(19) United States
(12) Patent Application Publication
(10) Pub. No.: US 2004/0035440 A1
(43) Pub. Date: Feb. 26, 2004

(54) Disposable dental floss holder and multi-function thereof

(76) Inventor: Jung Cheng, Taipei (TW)

Correspondence Address: JOHNSON & ASSOCIATES, PC, 14625 BALTIMORE AVENUE # 282, LAUREL, MD, 20707, US

(21) Appl. No.: 10/393,263

(22) Filed: Mar. 21, 2003

(30) Foreign Application Priority Data
Aug. 20, 2002 (TW) 091212877

(51) Int. Cl. A61C 15/00

(52) U.S. Cl. 132/323

(57) ABSTRACT

The present invention disclosed a disposable dental floss holder and multi-function thereof, comprising a force applied handle and a tooth pick portion in connection with one end of force applied handle, said tooth pick portion having a reversed U shape frame and the floss is mounted on said frame, and more particularly said reversed U shape frame having end rod is in connection with said force applied handle, and side rods are vertically extruded from two ends of said end rod, said dental floss is mounted in between said side rods, and said end rod and said force applied handle are orthogonal to each other making disposable dental floss holder as a T shape pattern; also in between said force applied handle and said side rods it may be formed with angle ranged from 90 degree to 180 degree. Further, said force applied handle at one end may be formed into a sharp tip or dental probe shape, or mounted with a small cotton ball (Q-Tip) to serve the multi-function purposes of the present invention.

### BACKGROUND OF THE INVENTION

1. Field of the Invention

The present invention relates to disposable dental floss holder, and more specifically to a disposable dental floss holder and multi-function thereof.

2. Description of Related Art

The conventional disposable dental floss holder 1, as shown in FIG. 1, has a force applied handle 11, a tooth pick portion 12 in connection with one end of force applied handle in a straight line and a tooth pick portion 12 mounted with a floss 13; the prior art disposable dental floss holder 1 has shown from its top view a “-” figure, and from mechanics viewpoint, the force applied handle 11 and hand may incorporate an inclined angle at mouth corner (not shown) when trying to pick back grinder tooth for example. Thus, the user may not be able to clean teeth with conventional dental tooth holder.

Furthermore, because conventional disposable dental floss holder 1 is a “-” figure, the force applied handle 11 and floss 13 are in a line, when force applied on the handle during tooth pick application may hurt user's oral or cause damage, especially for periodontosis patient may result in bleeding, and thus may incur certain adverse consequences to human beings' tooth health.

Therefore, disposable dental floss holder manufacturer has to supply better products to prevent above mentioned flaws from occurring.

### SUMMARY OF THE INVENTION

The main object of the present invention is to provide a disposable dental floss holder with multi-function to improve safety of tooth pick and maintain tooth health of users.

A disposable dental floss holder with multi-function of the present invention comprising a force applied handle and a tooth pick portion in connection with one end of force applied handle, said tooth pick portion having a reversed U shape frame and the floss is mounted on said frame, and more particularly said reversed U shape frame having end rod is in connection with said force applied handle, and side rods are vertically extruded from two ends of said end rod, said dental floss is mounted in between said side rods, and let said end rod and said force applied handle are orthogonal to each other making disposable dental floss holder as a T shape pattern viewed from top, by use of said T shape pattern floss holder, one can pick from any angle to the back grinder tooth so as to improve the safety of tooth pick and effectiveness of maintaining tooth health.

Other objects, advantages, and features of the invention will become more apparent from the following detailed description when in conjunction with the accompanying drawings.

### BRIEF DESCRIPTION OF DRAWINGS

FIG. 1 is a perspective view of conventional disposable dental floss holder;

FIG. 2 is a perspective view of first one of the preferred embodiments of the present invention; it illustrates the force applied handle and the end rod are in 90 degree orthogonal relationship, and a small cotton ball is mounted on the other end of the force applied handle;

FIG. 3 is a perspective view of second one of the preferred embodiments of the present invention; it illustrates a dental probe is formed on the other end of the force applied handle;

FIG. 4 is a perspective view of third one of the preferred embodiments of the present invention; it illustrates a sharp tip is formed on the other end of the force applied handle;

FIG. 5a is a perspective view of fourth one of the preferred embodiments of the present invention, it illustrates in between the force applied handle and side rod it is constituted an angle ranged from 90 degree to 180 degree, and a small cotton ball is mounted on the other end of the force applied handle;

FIG. 5b is a side view of FIG. 5a;

FIG. 6a is a perspective view of fifth one of the preferred embodiments of the present invention, it illustrates a dental probe is formed on the other end of the force applied handle;

FIG. 6b is a side view of FIG. 6a;

FIG. 7a is a perspective view of sixth one of the preferred embodiments of the present invention; it illustrates a sharp tip is formed on the other end of the force applied handle; and,

FIG. 7b is a side view of FIG. 7a.

### DETAILED DESCRIPTION OF PREFERRED EMBODIMENTS

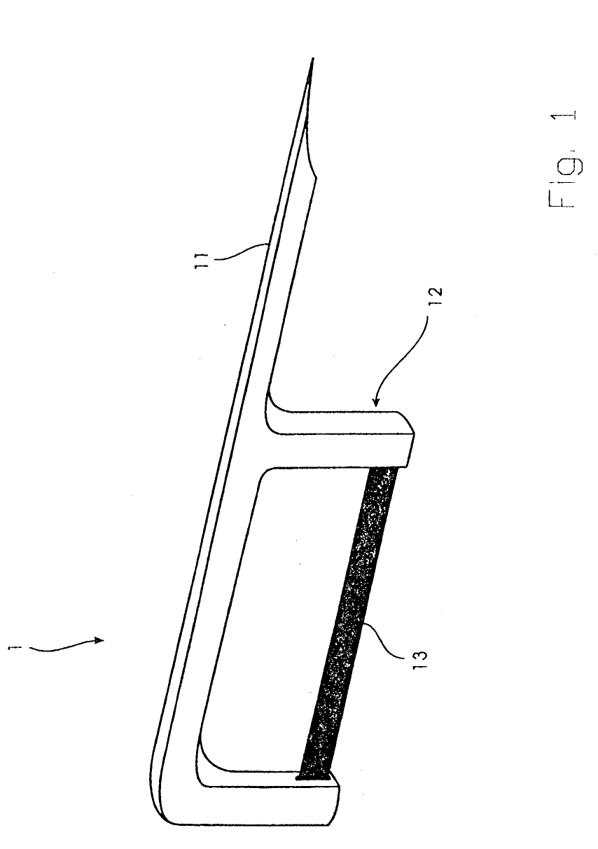

FIG. 1 illustrates a conventional straight line disposable dental floss holder.

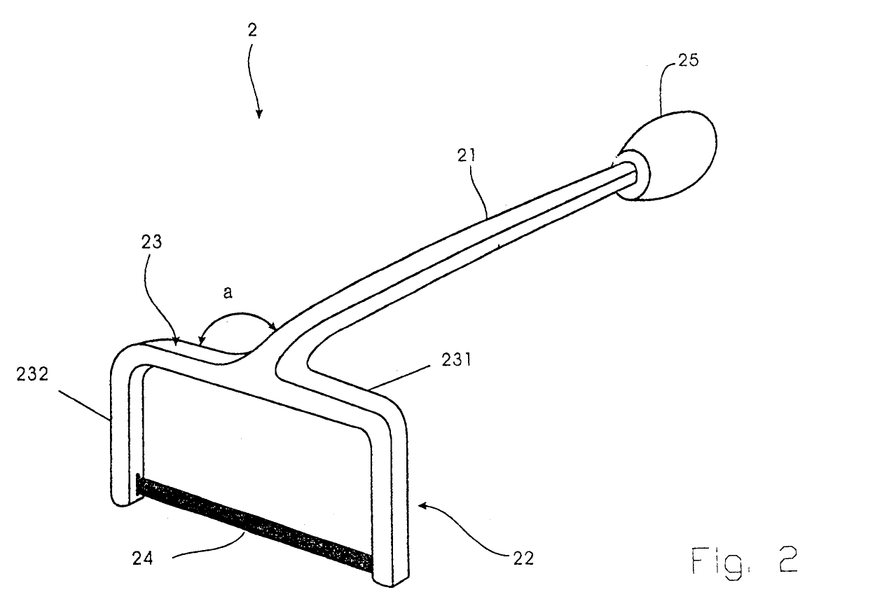

FIG. 2 illustrates a disposable dental floss holder 2 with multi-function, comprising a force applied handle 21 and a tooth pick portion 22 in connection with one end of force applied handle 21, said tooth pick portion 22 having a reversed U shape frame 23 and the floss is mounted on said frame, and more particularly said reversed U shape frame having end rod 231 is in connection with said force applied handle 21, and side rods 232 are vertically extruded from two ends of said end rod 231, said dental floss 24 is mounted in between said side rods 232, and said end rod 231 and said force applied handle 21 are orthogonal to each other (shown as “a” angle) making disposable dental floss holder 2 as a T shape pattern viewed from top; also said force applied handle 21 mounted with a small cotton ball 25, looks like Q-Tip, on the other end for cleaning teeth soon after the application of tooth pick.

Because the disposable dental floss holder 2 of the present invention is a T shape pattern, and from mechanics viewpoint said disposable dental floss holder 2 has a wider range of force applying angle, user may easily pick the back grinder tooth, besides, the connection portion of the force applied handle 21 and reversed U shape frame 23 differs from prior art, formed at one side of a line structure, to the center of end rod 231 of a reversed U shape frame 23, thus enables user to uniformly applied force onto the floss 24 to avoid causing jerking movement due to uneven force applied onto the floss 24 and ease the tooth pick application at difficult spots within oral.

Furthermore, one of the advantages of the present invention is that the uniformly controlled applied force can reduce jerks of disposable dental floss holder 2 so as to eliminate the possibility of hurting or piercing oral to an extent, and thus to secure the health of human beings.

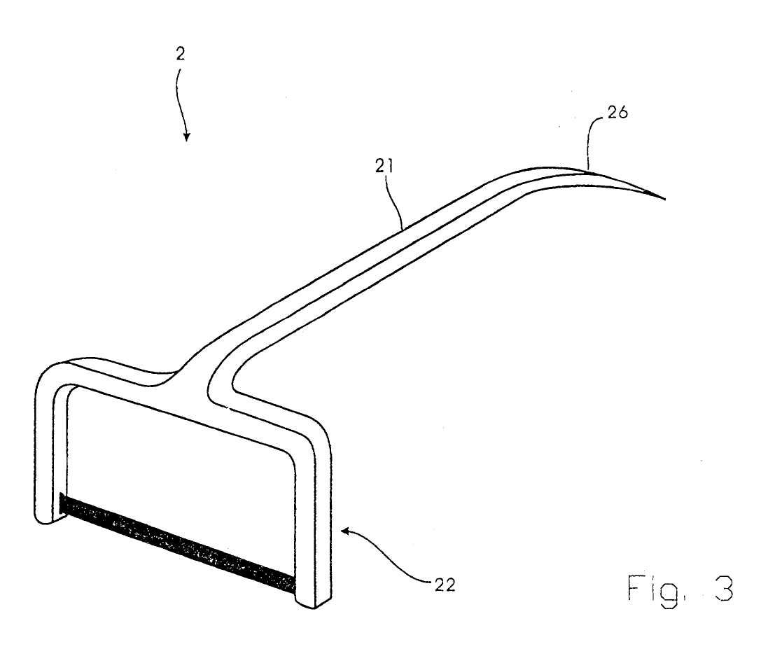

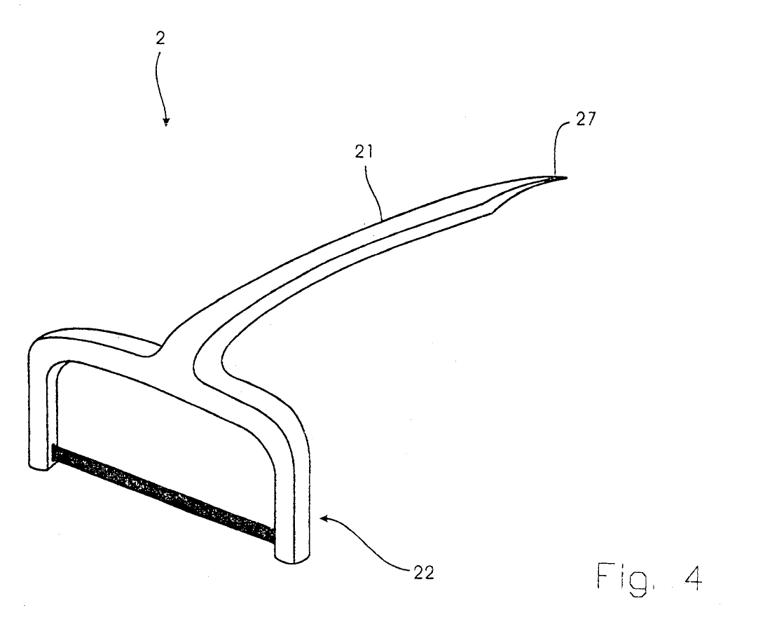

With reference to FIG. 3 and FIG. 4, it illustrates second and third preferred embodiments of the present invention respectively, wherein the structure of the second and third preferred embodiments are same as first one, comprising a force applied handle 21 and a tooth pick portion 22, the differences are that in FIG. 3 there is a dental probe 26 formed on the other end of the force applied handle 21, said dental probe 26 is to serve deep tooth pick application for the user with big slit between teeth or slightly decayed teeth, and in FIG. 4, there is a sharp tip 27 formed on the other end of the force applied handle 21 to serve general purpose of tooth pick application.

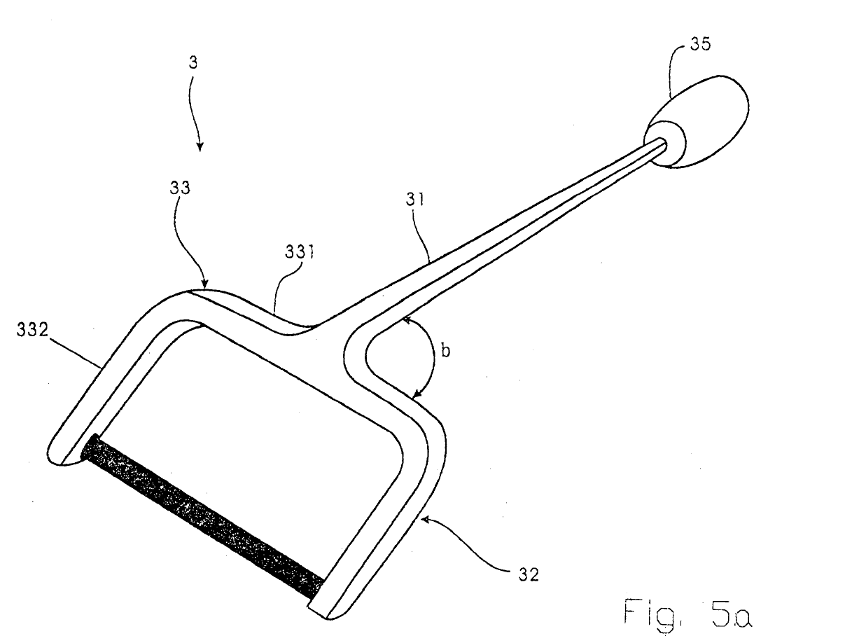

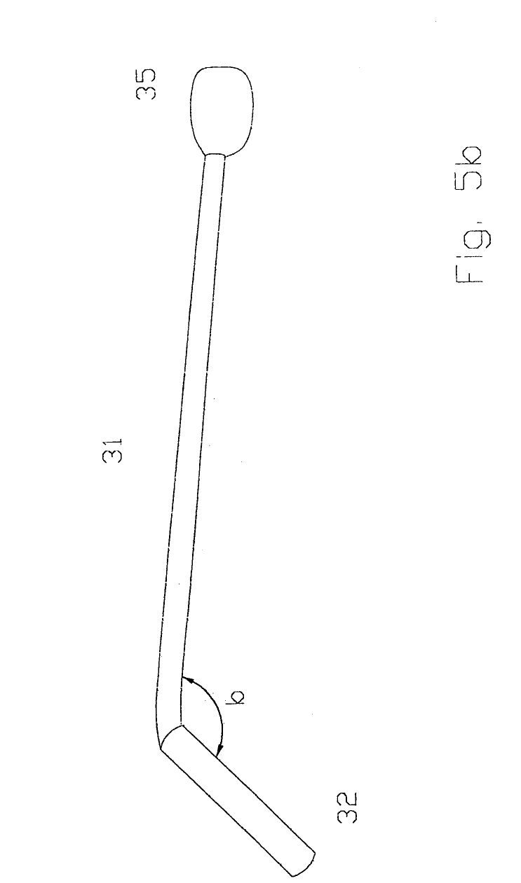

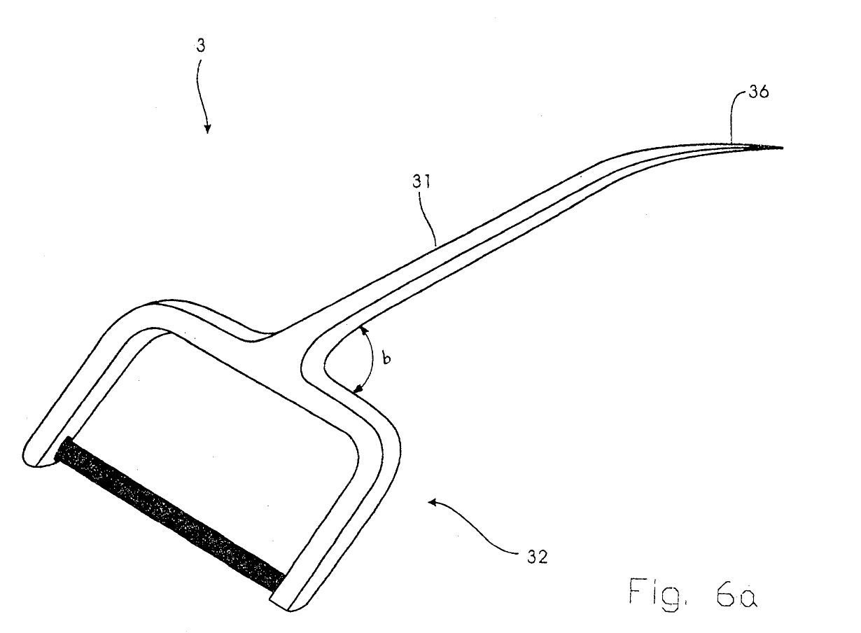

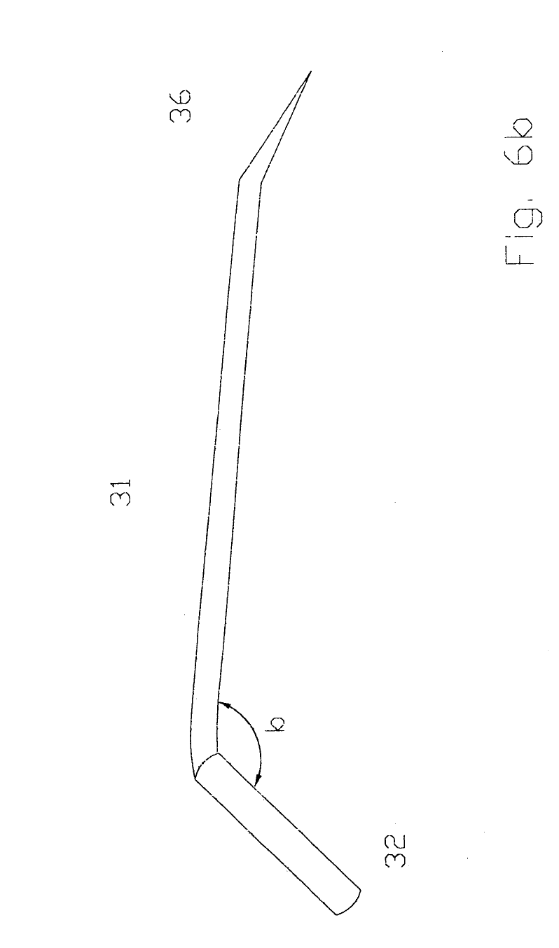

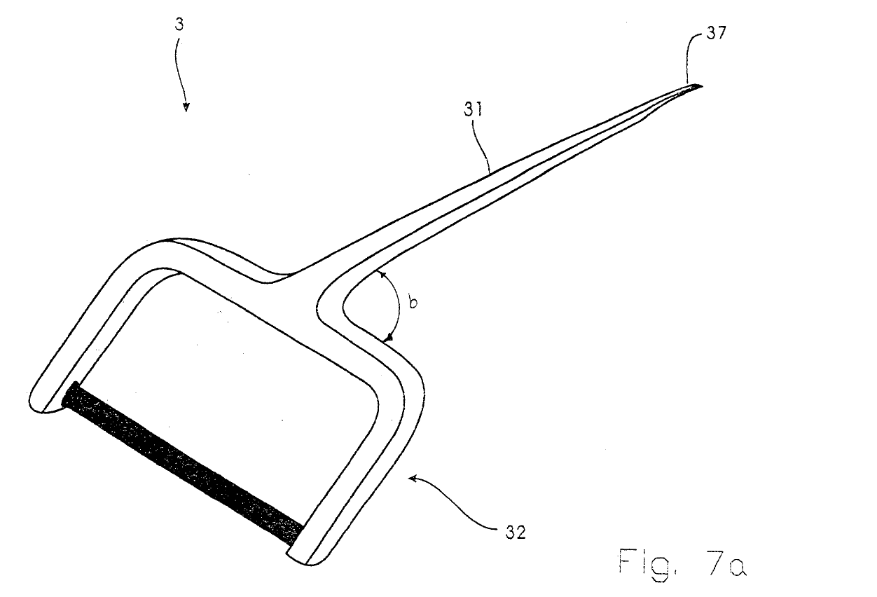

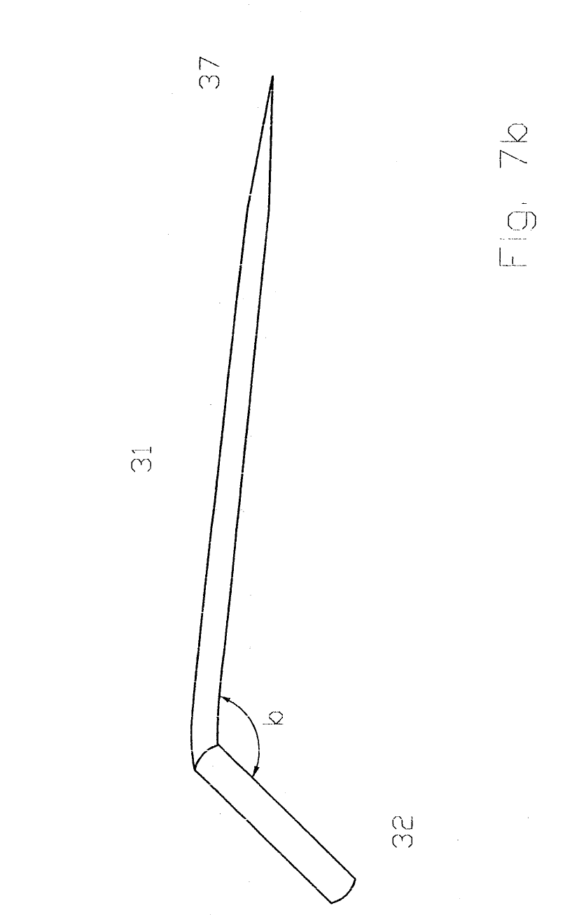

With reference to FIGS. 5a, 5b, FIGS. 6a, 6b and FIGS. 7a, 7b, it illustrates fourth, fifth and sixth preferred embodiments of the present invention respectively, wherein the structure of the fourth, fifth and sixth preferred embodiments are as same as the preceding ones, except the portions at the other end of force applied handle, comprising a force applied handle 31 and a tooth pick portion 32, said tooth pick portion 32 having a reversed U shape frame 33, said reversed U shape frame 33 consisting of end rod 331 and side rods 332, and may be configured with various patterns at the other end of the force applied handle, such as in FIG. 5 showing a small cotton ball 35 mounted on the other end of the force applied handle 31, in FIG. 6 showing a dental probe 36 formed on the other end of the force applied handle 31 and in FIG. 6 showing a sharp tip 37 formed on the other end of the force applied handle 31. The differences from preceding ones are the angle constituted in between said force applied handle 31 and said side rods 332 is ranged from 90 degree to 180 degree (as shown in FIG. 5b, FIG. 6b, FIG. 7b respectively). Such variant formation of said angle between 90 degree and 180 degree is so designed and manufactured as to be feasible for different oral structure from different countries and regions.

From aforementioned descriptions, it is to be understood that the end rod and the force applied handle are constituted in such manner to form a T shape pattern so as to change the application angle of tooth pick and enable user to apply in any angle to reach back grinder tooth during tooth pick application. Also, the angle constituted in between the force applied handle and the side rods is ranged from 90 degree to 180 degree, such variant formation of said angle between 90 degree and 180 degree is so designed for different oral structure from different countries. Besides, the T shape pattern disposable dental floss holder of the present invention, during the tooth pick application by user, the uniformly controlled applied force can prevent the tooth pick from hurting oral to an extent, so as to improve the safety of tooth pick and effectiveness of maintaining tooth health.

Although the present invention has been explained in relation to its preferred embodiment, it is to be understood that many other possible modification and variations can be made without departing from the spirit and scope of the invention as hereinafter claimed.

What is claimed is:

1. A disposable dental floss holder with multi-function, comprising a force applied handle and a tooth pick portion in connection with one end of force applied handle, said tooth pick portion having a reversed U shape frame and the floss is mounted on said frame, wherein characterized in said reversed U shape frame having end rod is in connection with said force applied handle, and side rods are vertically extruded from two ends of said end rod, said dental floss is mounted in between said side rods, and said end rod and said force applied handle are orthogonal to each other making disposable dental floss holder as a T shape pattern viewed from top.

2. The disposable dental floss holder with multi-function as in claim 1, wherein a small cotton ball is mounted on the other end of the force applied handle.

3. The disposable dental floss holder with multi-function as in claim 1, wherein a dental probe is formed on the other end of the force applied handle.

4. The disposable dental floss holder with multi-function as in claim 1, wherein a sharp tip is formed on the other end of the force applied handle.

5. The disposable dental floss holder with multi-function as in claim 1, wherein in between said force applied handle and said side rod it is constituted an angle ranged from 90 degree to 180 degree from left or right side view.
